(19) United States
(12) Patent Application Publication
(10) Pub. No.: US 2003/0139499 A1
(43) Pub. Date: Jul. 24, 2003

(54) Photo-cured and stabilized coatings

(76) Inventors: Joseph Suhadolnik, Yorktown Heights, NY (US); Mervin Wood, Poughquag, NY (US); Ramanathan Ravichandran, Suffern, NY (US); Walter Renz, Brookfield, CT (US); Andrea Smith, Wingdale, NY (US); Nancy Cliff, Ringwood, NJ (US); Eugene Sitzmann, Hartsdale, NY (US); David Bramer, Putnam Valley, NY (US)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/302,110

(22) Filed: Nov. 22, 2002

Related U.S. Application Data
(60) Provisional application No. 60/413,935, filed on Sep. 26, 2002.
(60) Provisional application No. 60/336,362, filed on Nov. 26, 2001.

(51) Int. Cl. C08K 5/34; C08G 2/00

(52) U.S. Cl. 524/91; 522/7

(57) ABSTRACT

Photo-cureable coating formulations which comprise a durable and/or red-shifted hydroxyphenylbenzotriazole ultraviolet light absorber (UVA) are effectively photocured employing a combination of α-hydroxy ketone and bisacylphosphine oxide photoinitiators. The combination of the photoinitiators bis(2,4,6-trimethylbenzoyl)phenylphosphine oxide and 1-hydroxycyclohexylphenylketone is especially effective for this purpose.

The present invention is aimed at a process for photo-curing coating formulations which comprise durable and/or red-shifted hydroxyphenylbenzotriazole ultraviolet light absorbers (UVA's).

Durable and/or red-shifted hydroxyphenylbenzotriazoles are disclosed for example in U.S. Pat. No. 5,977,219. Solar control films comprising durable and/or red-shifted hydroxyphenylbenzotriazoles are disclosed in U.S. Pat. Nos. 6,187,845 and 6,191,199.

Surprisingly, photo-curable coating formulations that comprise durable and/or red-shifted hydroxyphenylbenzotriazole UV absorbers are effectively photo-cured by employing a combination of α-hydroxy ketone and bisacylphosphine oxide photoinitiators. This is surprising since UV absorbers block light that is required for light curing. This is especially surprising for highly effective UV absorbers such as the present hydroxyphenylbenzotriazoles since they absorb more UV light by virtue of being red-shifted.

An object of this invention is to provide for protective thin photo-cured coatings which comprise high performance durable and/or red-shifted hydroxyphenylbenzotriazole UV absorbers.

### DETAILED DISCLOSURE

Disclosed is a process for forming a protective film coating

which process comprises curing a coating composition by irradiating said composition with ultraviolet radiation or daylight or with light sources equivalent to daylight,

wherein said coating composition comprises

a) at least one ethylenically unsaturated polymerizable compound,

b) at least one durable and/or red-shifted hydroxyphenylbenzotriazole UV absorber and

c) a combination of photoinitiators comprising

i) at least one α-hydroxy ketone photoinitiator and

ii) at least one bisacylphosphine oxide photoinitiator.

The durable and/or red-shifted hydroxyphenylbenzotriazoles of the present invention are known and are described in U.S. Pat. Nos. 5,977,219, 6,166,218 and 6,262,151 and U.S. application Ser. No. 09/851,453, filed May 8, 2001, and Ser. No. 09/772,245, filed Jan. 29, 2001, the relevant disclosures of which are hereby incorporated by reference.

The hydroxyphenylbenzotriazoles are for instance of formula

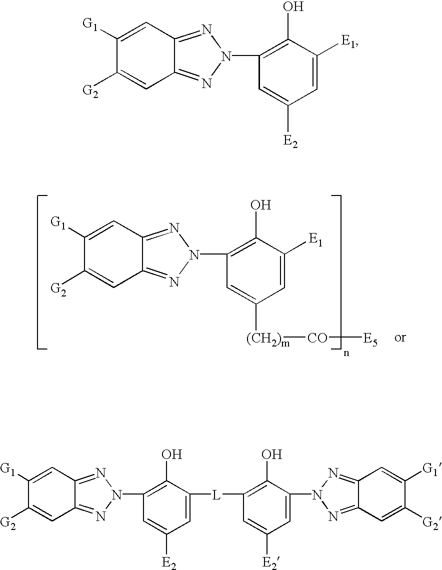

wherein

G₁ and G₁′ are independently hydrogen or halogen,

G₂ and G₂′ are independently halogen, nitro, cyano, perfluoroalkyl of 1 to 12 carbon atoms, —COOG₃, —P(O)(C₆H₅)₂, —CO-G₃, —CO—NH-G₃, —CO—N(G₃)₂, —N(G₃)—CO-G₃, E₃SO— or E₃SO₂—; or G₂′ is also hydrogen,

G₃ is hydrogen, straight or branched chain alkyl of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms,

E₁ is hydrogen, straight or branched chain alkyl of 1 to 24 carbon atoms, straight or branched chain alkenyl of 2 to 24 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms; or E1 is alkyl of 1 to 24 carbon atoms substituted by one or two hydroxy groups,

when E₁ is phenylalkyl of 7 to 15 carbon atoms or phenyl, or said phenyl or said phenylalkyl substituted on the phenyl ring by 1 to 4 alkyl of 1 to 4 carbon atoms, G₂ may also be hydrogen,

E₂ and E₂′ are independently straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by one to three alkyl of 1 to 4 carbon atoms; or E₂ and E₂′ are independently said alkyl of 1 to 24 carbon atoms or said alkenyl of 2 to 18 carbon atoms substituted by one or more —OH, —OCOE₁₁, —OE₄, —NCO, —NH₂, —NHCOE₁₁, —NHE₄ or —N(E₄)₂, or mixtures thereof, where E₄ is straight or branched chain alkyl of 1 to 24 carbon atoms; or said alkyl or said alkenyl interrupted by one or more —O—, —NH— or —NE₄— groups or mixtures thereof and which can be unsubstituted or substituted by one or more —OH, —OE₄ or —NH₂ groups or mixtures thereof,

E₃ is alkyl of 1 to 20 carbon atoms, hydroxyalkyl of 2 to 20 carbon atoms, alkyl substituted by alkoxycarbonyl of 2 to 9 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms,

n is 1 or 2,

when n is 1,

E₅ is OE₆ or NE₇E₈, or E₅ is —PO(OE₁₂)₂, —OSi(E₁₁)₃ or —OCO-E₁₁, or straight or branched chain C₁-C₂₄alkyl which is interrupted by —O—, —S— or —NE₁₁ and which can be unsubstituted or substituted by —OH or —OCO-E₁₁, C₅-C₁₂ cycloalkyl which is unsubstituted or substituted by —OH, straight chain or branched C₂-C₁₈alkenyl which is unsubstituted or substituted by —OH, C₇-C₁₅aralkyl, —CH₂—CHOH-E₁₃ or glycidyl,

or E₅ is —X-(Z)ₚ—Y-E₁₅

where

X is —O— or —N(E₁₆)—,

Y is —O— or —N(E₁₇)—,

Z is C₂-C₁₂-alkylene, C₄-C₁₂-alkylene interrupted by one to three nitrogen atoms, oxygen atoms or a mixture thereof, or is C₃-C₁₂-alkylene, butenylene, butynylene, cyclohexylene or phenylene, each substituted by a hydroxyl group,

m is zero, 1 or 2,

p is 1, or p is also zero when X and Y are —N(E₁₆)— and —N(E₁₇)—, respectively,

E₆ is hydrogen, straight or branched chain C₁-C₂₄alkyl which is unsubstituted or substituted by one or more OH, OE₄ or NH₂ groups, or —OE₆ is —(OCH₂CH₂)_{w}OH or —(OCH₂CH₂)_{w}OE₂₁ where w is 1 to 12 and E₂₁ is alkyl of 1 to 12 carbon atoms,

E₇ and E₈ are independently hydrogen, alkyl of 1 to 18 carbon atoms, straight or branched chain C₃-C₁₈alkyl which is interrupted by —O—, —S— or —NE₁₁—, C₅-C₁₂cycloalkyl, C₆-C₁₄aryl or C₁-C₃hydroxylalkyl, or E₇ and E₈ together with the N atom are a pyrrolidine, piperidine, piperazine or morpholine ring,

E₉ is C₂-C₈alkylene, C₄-C₈alkenylene, C₄alkynylene, cyclohexylene, straight or branched chain C₄-C₁₀alkylene which is interrupted by —O— or by —CH₂—CHOH—CH₂—O-E₁₄-O—CH₂—CHOH—CH₂—,

E₁₀ being straight or branched chain C₂-C₁₂alkylene which may be interrupted by —O—, cyclohexylene, or

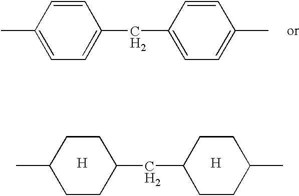

or E₁₀ and E₁₁, with the two nitrogen atoms form a piperazine ring,

E₁₁ is hydrogen, straight or branched chain C₁-C₁₈alkyl, C₅-C₁₂cyCloalkyl, straight or branched chain C₂-C₁₈alkenyl, C₆-C₁₄aryl or C₇-C₁₅aralkyl,

E₁₂ is straight or branched chain C₁-C₁₈alkyl, straight or branched chain C₃-C₁₈alkenyl, C₅-C₁₀cycloalkyl, C₆-C₁₆aryl or C₇-C₁₅aralkyl,

E₁₃ is H, straight chain or branched C₁-C₁₈alkyl which is substituted by —PO(OE₁₂)₂, phenyl which is unsubstituted or substituted by OH, C₇-C₁₅aralkyl or —CH₂OE₁₂,

E₁₄ is straight or branched chain C₂-C₈alkylene, straight or branched chain C₄-C₁₀alkylene which is interrupted by —O—, cycloalkylene, arylene or

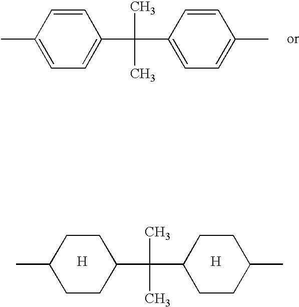

where E₇ and E₈ are independently hydrogen, alkyl of 1 to 18 carbon atoms or E₇ and E₈ together are alkylene of 4 to 6 carbon atoms, 3-oxapentamethylene, 3-iminopentamethylene or 3-methyliminopentamethylene,

E₁₅ is a group —CO—C(E₁₈)═C(H)E₁₉ or, when Y is —N(E₁₇)—, forms together with E₁₇ a group —CO—CH═CH—CO—, wherein E₁₈ is hydrogen or methyl, and E₁₉ is hydrogen, methyl or —CO—X-E₂₀, wherein E₂₀ is hydrogen, C₁-C₁₂-alkyl or a group of the formula

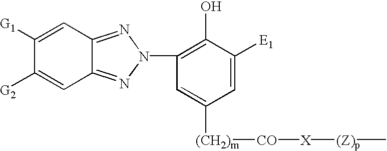

where E₁, G₂, X, Z, m and p are as defined above, and E₁₆ and E₁₇ independently of one another are hydrogen, C₁-C₁₂-alkyl, C₃-C₁₂-alkyl interrupted by 1 to 3 oxygen atoms, or is cyclohexyl or C₇-C₁₅aralkyl, and E₁₆together with E₁₇ in the case where Z is ethylene, also forms ethylene and

L is alkylene of 1 to 12 carbon atoms, alkylidene of 2 to 12 carbon atoms, benzylidene, p-xylylene, α,α,α′,α′-tetramethyl-m-xylylene or cycloalkylidene and

when n is 2,

one of G₂ is also hydrogen and

E₅ is one of divalent radicals —O-E₉-O— or —N(E₁₁)-E₁₀-N(E₁₁)-.

For instance, the hydroxyphenylbenzotriazoles are of the formula

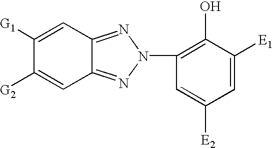

wherein

G₁ is hydrogen,

G₂ is hydrogen, cyano, chloro, fluoro, —CF₃, —CO-G₃, E₃SO— or E₃SO₂—,

G₃ is straight or branched chain alkyl of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms,

E₁ is phenylalkyl of 7 to 15 carbon atoms, phenyl, or said phenyl or said phenylalkyl substituted on the phenyl ring by 1 to 4 alkyl of 1 to 4 carbon atoms,

E₂ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or E₂ is said alkyl of 1 to 24 carbon atoms or said alkenyl of 2 to 18 carbon atoms substituted by one or more —OH, —OCOE₁₁, —OE₄, —NCO, —NH₂, —NHCOE₁₁, —NHE₄ or —N(E₄)₂, or mixtures thereof, where E₄ is straight or branched chain alkyl of 1 to 24 carbon atoms; or said alkyl or said alkenyl interrupted by one or more —O—, —NH— or —NE₄— groups or mixtures thereof and which can be unsubstituted or substituted by one or more —OH, —OE₄ or —NH₂ groups or mixtures thereof;

E₃ is alkyl of 1 to 20 carbon atoms, hydroxyalkyl of 2 to 20 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms;

or where

G₁ is hydrogen,

G₂ is chloro, fluoro, —CF₃, E₃SO— or E₃SO₂—,

E₁ is hydrogen or straight or branched alkyl of 1 to 24 carbon atoms,

E₂ is as defined above, and

E₃ is straight or branched chain alkyl of 1 to 7 carbon atoms.

Another embodiment is where the hydroxyphenylbenzotriazole UVA's are of the formula

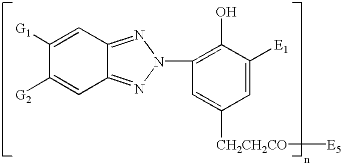

wherein

G₁ is hydrogen,

G₂ is —CF₃ or fluoro,

E₁ is hydrogen, straight or branched alkyl of 1 to 24 carbon atoms or phenylalkyl of 7 to 15 carbon atoms,

when E₁ is phenylalkyl of 7 to 15 carbon atoms, G₂ may also be hydrogen,

E₅ is —OE₆ or —NE₇E₈, or

E₅ is —X-(Z)ₚ—Y-E₁₅

wherein

X is —O— or —N(E₁₆)—,

Y is —O— or —N(E₁₇)—,

Z is C₂-C₁₂-alkylene, C₄-C₁₂-alkylene interrupted by one to three nitrogen atoms, oxygen atoms or a mixture thereof, or is C₃-C₁₂-alkylene, butenylene, butynylene, cyclohexylene or phenylene, each substituted by a hydroxyl group,

m is 0, 1, 2 or 3,

p is 1, or p is also zero when X and Y are —N(E₁₆)- and —N(E₁₇)—, respectively,

E₁₅ is a group —CO—C(E₁₈)═C(H)E₁₉ or, when Y is —N(E₁₇)—, forms together with E₁₇ a group —CO—CH═CH—CO—, wherein E₁₈ is hydrogen or methyl, and E₁₉ is hydrogen, methyl or —CO—X-E₂₀, wherein E₂₀ is hydrogen, C₁-C₁₂-alkyl or a group of the formula

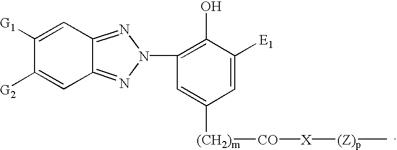

Still another embodiment is where the hydroxyphenylbenzotriazole UVA's are of the formula

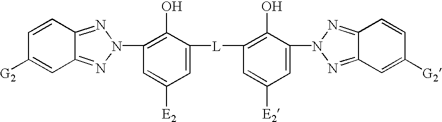

wherein

G₂ is —CF₃,

G_{2′} is hydrogen or —CF₃,

E₂ and E₂′ are independently straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; and

L is alkylene of 1 to 12 carbon atoms, alkylidene of 2 to 12 carbon atoms, benzylidene, p-xylylene, α,α,α′,α′-tetramethyl-m-xylylene or cycloalkylidene.

In another embodiment, the hydroxyphenylbenzotriazole UVA's are of the formula

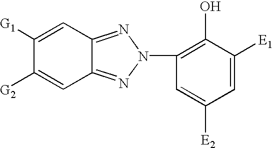

wherein

G₁ is hydrogen,

G₂ is —CF₃,

E₁ is phenylalkyl of 7 to 15 carbon atoms, phenyl, or said phenyl or said phenylalkyl substituted on the phenyl ring by 1 to 4 alkyl of 1 to 4 carbon atoms,

E₂ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or E₂ is said alkyl of 1 to 24 carbon atoms or said alkenyl of 2 to 18 carbon atoms substituted by one or more —OH, —OCOE₁₁, —NH₂ or —NHCOE₁₁, or mixtures thereof, or said alkyl or said alkenyl interrupted by one or more —O— and which can be unsubstituted or substituted by one or more —OH,

or where

G₁ is hydrogen,

G₂ is —CF₃,

E₁ is hydrogen, straight or branched alkyl of 4 to 24 carbon atoms or phenylalkyl of 7 to 15 carbon atoms, and

E₂ is as defined above.

In another embodiment, the hydroxyphenylbenzotriazole UVA's are of the formula

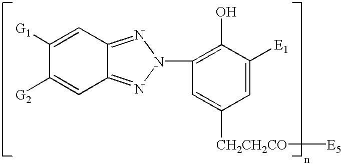

wherein

G₁ is hydrogen,

G₂ is —CF₃,

E₁ is hydrogen, straight or branched alkyl of 4 to 24 carbon atoms or phenylalkyl of 7 to 15 carbon atoms,

E₅ is —OE₆ or —NE₇E₈,

E₆ is hydrogen, straight or branched chain C₁-C₂₄alkyl which is unsubstituted or substituted by one or more OH groups, or —OE₆ is —(OCH₂CH₂)_{w}OH or —(OCH₂CH₂)_{w}OE₂₁where w is 1 to 12 and E₂₁ is alkyl of 1 to 12 carbon atoms and

E₇ and E₈ are independently hydrogen, alkyl of 1 to 18 carbon atoms, straight or branched chain C₃-C₁₈alkyl which is interrupted by —O—, —S— or —NE₁₁—, C₅-C₁₂cycloalkyl, C₆-C₁₄aryl or C₁-C₃hydroxylalkyl, or E₇ and E₈ together with the N atom are a pyrrolidine, piperidine, piperazine or morpholine ring.

For example, the hydroxyphenylbenzotriazoles are of the formula

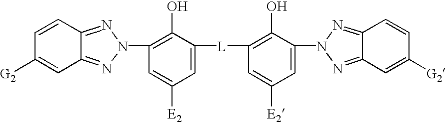

wherein

G₂ is —CF₃,

G_{2′} is hydrogen or —CF₃,

E₂ and E₂′ are independently straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms and

L is methylene.

For example, the hydroxyphenylbenzotriazole UVA is a compound selected from the group consisting of

(a) 5-trifluoromethyl-2-(2-hydroxy-3-α-cumyl-5-tert-octylphenyl)-2H-benzotriazole;

(b) 5-trifluoromethyl-2-(2-hydroxy-5-tert-octylphenyl)-2H-benzotriazole;

(c) 5-trifluoromethyl-2-(2-hydroxy-3,5-di-tert-octylphenyl)-2H-benzotriazole;

(d) 2,2′-methylene-bis[6-(5-trifluoromethyl-2H-benzotriazol-2-yl)-4-tert-octylphenol];

(e) methylene-2-[4-tert-octyl-6-(2H-benzotriazol-2-yl)phenol]2′-[4-tert-butyl-6-(5-trifluoro-methyl-2H-benzotriazol-2-yl)phenol];

(f) 3-(5-trifluoromethyl-2H-benzotriazol-2-yl)-5-tert-butyl-4-hydroxyhydrocinnamic acid;

(g) methyl 3-(5-trifluoromethyl-2H-benzotriazol-2-yl)-5-tert-butyl4-hydroxy-hydrocinnamate;

(h) isooctyl 3-(5-trifluoromethyl-2H-benzotriazol-2-yl)-5-tert-butyl-4-hydroxy-hydrocinnamate;

(i) 5-trifluoromethyl-2-[2-hydroxy-5-(3-hydroxypropyl)phenyl]-2H-benzotdazole;

(j) 5-butylsulfonyl-2-(2-hydroxy-3-α-cumyl-5-tert-octylphenyl)-2H-benzotriazole;

(k) 5-octylsulfonyl-2-(2-hydroxy-3,5-di-α-cumylphenyl)-2H-benzotriazole;

(l) 5-dodecylsulfonyl-2-(2-hydroxy-3,5-di-tert-butylphenyl)-2H-benzotdazole;

(m) 5-octylsulfonyl-2-(2-hydroxy-3,5-di-tert-octylphenyl)-2H-benzotriazole;

(n) 5-trifluoromethyl-2-(2-hydroxy-3-α-cumyl-54ert-butylphenyl)-2H-benzotdazole;

(o) 5-trifluoromethyl-2-(2-hydroxy-3-α-cumyl-5-nonylphenyl)-2H-benzotriazole;

(p) 5-trifluoromethyl-2-[2-hydroxy-3-α-cumyl-5-(2-hydroxyethyl)phenyl]-2H-benzotriazole;

(q) 5-trifluoromethyl-2-[2-hydroxy-3-α-cumyl-5-(3-hydroxypropyl)phenyl]-2H-benzo-triazole;

(r) 5-trifluoromethyl-2-(2-hydroxy-3,5-di-tert-amylphenyl)-2H-benzotriazole;

(s) 5-trifluoromethyl-2-(2-hydroxy-3,5-di-tert-butylphenyl)-2H-benzotriazole;

(t) 5-trifluoromethyl-2-(2-hydroxy-3-dodecyl-5-methylphenyl)-2H-benzotdazole;

(u) 5-trifluoromethyl-2-[2-hydroxy-3-tert-butyl-5-(3-hydroxypropyl)phenyl)-2H-benzo-triazole;

(v) 5-trifluoromethyl-2-[2-hydroxy-3-tert-butyl-5-(2-hydroxyethyl)phenyl]-2H-benzo-triazole;

(w) 5-trifluoromethyl-2-[2-hydroxy-5-(2-hydroxyethyl)phenyl]-2H-benzotriazole;

(x) 5trifluoromethyl-2-(2-hydroxy-3,5-di-α-cumylphenyl)-2H-benzotriazole;

(y) 5-fluoro-2-(2-hydroxy-3,5-di-α-cumylphenyl)-2H-benzotriazole;

(z) 5-butylsulfonyl-2-(2-hydroxy-3,5-di-α-cumylphenyl)-2H-benzotriazole;

(aa) 5-butylsulfonyl-2-(2-hydroxy-3,5-di-ert-butylphenyl)-2H-benzotriazole;

(bb) 5-butylsulfonyl-2-(2-hydroxy-3,5-di-tert-octylphenyl)-2H-benzotriazole;

(cc) 5-phenylsulfonyl-2-(2-hydroxy-3,5-di-tert-butylphenyl)-2H-benzotriazole;

(dd) 5-chloro-2-(2-hydroxy-3,5-di-α-cumylphenyl)-2H-benzotriazole;

(ee) 5-chloro-2-(2-hydroxy-3-α-cumyl-5-tert-octylphenyl)-2H-benzotriazole;

(ff) isooctyl 3-(5-chloro-2H-benzotriazol-2-yl)-5-tert-butyl-4-hydroxyhydrocinnamate;

(gg) 2-(2-hydroxy-3-α-cumyl-5-tert-octylphenyl)-2H-benzotriazole;

(hh) 2-(2-hydroxy-3,5-di-α-cumyl-phenyl)-2H-benzotriazole;

(ii) 5-chloro-2-(2-hydroxy-3,5-di-tert-butylphenyl)-2H-benzotriazole; and

(jj) 5-chloro-2-(2-hydroxy-3-tert-butyl-5-methylphenyl)-2H-benzotriazole.

The present hydroxyphenylbenzotriazoles are employed from about 0.5% to about 5% by weight, based on the weight of the coating composition. For example, the present hydroxyphenylbenzotriazoles are employed from about 0.5% to about 4%, from about 0.5% to about 3%, from about 0.5% to about 2%, or from about 0.5% to about 1% by weight, based on the weight of the coating composition. For instance, the present hydroxyphenylbenzotriazoles are employed from about 1% to about 5%, from about 2% to about 5%, from about 3% to about 5%, or from about 4% to about 5% by weight, based on the weight of the coating composition. For instance, the present hydroxyphenylbenzotriazoles are employed from about 1% to about 4.5% or from about 2% to about 4% by weight, based on the weight of the coating formulation.

The α-hydroxy ketone and bisacylphosphine oxide photoinitiators of this invention are known and are disclosed for example in U.S. Pat. Nos. 5,942,290, 5,534,559 and 6,020,528, the relevant disclosures of which are hereby incorporated by reference.

The α-hydroxy ketone photoinitiators are of the formula

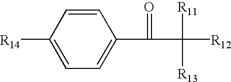

where

R₁₁ and R₁₂ independently of one another are hydrogen, C₁-C₆ alkyl, phenyl, C₁-C₆ alkoxy, OSiR₁₆(R₁₇)₂ or —O(CH₂CH₂O)_{q}—C₁-C₆ alkyl, or

R₁₁ and R₁₂, together with the carbon atom to which they are attached, form a cyclohexyl ring;

q is a number from 1 to 20;

R₁₃ is OH, C₁-C₁₆ alkoxy or —O(CH₂CH₂O)_{q}—C₁-C₆ alkyl;

R₁₄ is hydrogen, C₁-C₁₈ alkyl, C₁-C₁₈ alkoxy, —OCH₂CH₂—OR₁₅, a group CH₂═C(CH₃)— or is

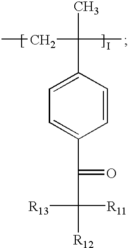

I is a number from 2 to 10;

R₁₅ is hydrogen, —COCH═CH₂ or —COC(CH₃)═CH₂; and

R₁₆ and R₁₇ independently of one another are C₁-C₈ alkyl or phenyl.

α-Hydroxy ketone photoinitiators that are of interest are those in which R₁₁ and R₁₂ independently of one another are hydrogen, C₁-C₆ alkyl or phenyl or R₁₁ and R₁₂, together with the carbon atom to which they are attached, form a cyclohexyl ring; R₁₃ is OH; and R₁₄ is hydrogen, C₁-C₁₂ alkyl, C₁-C₁₂ alkoxy, —OCH₂CH₂OR₁₅, —C(CH₃)═CH₂ or is

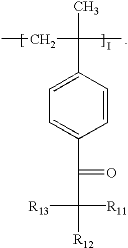

For example, suitable as the α-hydroxy ketone photoinitiators are those in which R₁₁ and R₁₂ independently of one another are methyl or ethyl or R₁₁ and R₁₂, together with the carbon atom to which they are attached, form a cyclohexyl ring; R₁₃ is hydrogen and R₁₄ is hydrogen, C₁-C₄ alkyl, C₁-C₄ alkoxy or —OCH₂CH₂OH.

For instance, suitable α-hydroxy ketone photoinitiators are

α-hydroxycyclohexyl phenyl ketone,

2-hydroxy-2-methyl-1-phenylpropanone,

2-hydroxy-2-methyl-1-(4-isopropylphenyl)propanone,

2-hydroxy-2-methyl-1-(4-dodecylphenyl)propanone and

2-hydroxy-2-methyl-1-[(2-hydroxyethoxy)phenyl]propanone.

The present α-hydroxy ketone photoinitiator is for example α-hydroxycyclohexylphenyl ketone, available from Ciba Specialty Chemicals as Irgacure® 184.

The bisacylphosphine oxide photoinitiators are of the formula

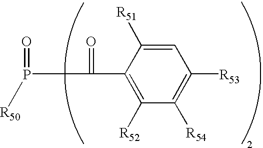

wherein

R₅₀ is C₁-C₁₂ alkyl, cyclohexyl or phenyl which is unsubstituted or is substituted by 1 to 4 halogen or C₁-C₈ alkyl,

R₅₁, and R₅₂ are each independently of the other C₁-C₈ alkyl,

R₅₃ is hydrogen or C₁-C₈ alkyl, and

R₅₄ is hydrogen or methyl.

For example, R₅₀ is C₂-C₁₀ alkyl, cyclohexyl or phenyl which is unsubstituted or is substituted by 1 to 4 C₁-C₄ alkyl, Cl or Br.

Another embodiment is where R₅₀ is C₃-C₈ alkyl, cyclohexyl or phenyl which is unsubstituted or is substituted in the 2-, 3-, 4- or 2,5-positions by C₁-C₄ alkyl.

For instance, R₅₀ is C₄-C₁₂ alkyl or cyclohexyl, R₅₁ and R₅₂ are each independently of the other C₁-C₈ alkyl and R₅₃ is hydrogen or C₁-C₈ alkyl.

For instance, R₅₁ and R₅₂ are C₁-C₄ alkyl and R₅₃ is hydrogen or C₁-C₄ alkyl.

Another emodiment is where R₅₁ and R₅₂ are methyl and R₅₃ is hydrogen or methyl.

For example R₅₁, R₅₂ and R₅₃ are methyl.

Another emodiment is where R₅₁, R₅₂ and R₅₃ are methyl and R₅₄ is hydrogen.

Another embodiment is where R₅₀ is C₃-C₈ alkyl.

For instance R₅₀ is isobutyl.

For example R₅₀ is phenyl.

The present bisacylphosphine oxide photoinitiator is for example lrgacure® 819, bis(2,4,6-trimethylbenzoyl)-phenylphosphine oxide, available from Ciba Specialty Chemicals.

Straight or branched chain alkyl is for example, methyl, ethyl, propyl, isopropyl, butyl, isobutyl, sec-butyl, tert-butyl, pentyl, isopentyl, hexyl, heptyl, octyl, nonyl, decyl or dodecyl.

The α-hydroxy ketone photoinitiators are present in the coating compositions of this invention from about 1% to about 7% by weight, based on the weight of the coating composition. For instance, the α-hydroxy ketone photoinitiators are present from about 1% to about 2%, from about 1% to about 3% from about 1% to about 4%, from about 1% to about 5%, or from about 1% to about 6% by weight, based on the weight of the coating formulation. For example, the α-hydoxy ketone photoinitiators are present from about 2% to about 7%, from about 3% to about 7%, from about 4% to about 7%, from about 5% to about 7%, or from about 6% to about 7% by weight, based on the weight of the coating composition. For example, the α-hydroxy ketone photoinitiators are present from about 2% to about 6% by weight, or from about 3% to about 5% by weight, based on the weight of the coating composition.

The present bisacylphosphine oxide photoinitiators are employed from about 0.1% to about 2% by weight, based on the weight of the coating composition. For instance, the present bisacylphosphine oxide photoinitiators are employed from about 0.1% to about 1.5%, from about 0.1% to about 1%, or from about 0.1% to about 0.5% by weight, based on the weight of the coating formulation. For example, the present bisacylphosphine oxide photoinitiators are employed from about 0.2% to 2%, from about 0.5% to about 2%, or from about 0.7% to about 2% by weight, based on the weight of the coating composition. For example, the present bisacylphosphine oxide photoinitators are employed from about 0.2% to about 1.5%, or from about 0.5 to about 1% by weight, based on the weight of the coating composition.

The α-hydroxy ketone photoinitiator is for example used in excess of the bisacylphosphine oxide photoinitiator.

The weight ratio of α-hydroxy ketone to bisacylphosphine oxide is for example from about 5:1 to about 15:1. For example, the weight ratio of α-hydroxy ketone to bisacylphosphine oxide is from about 5:1 to about 12:1, from about 5:1 to about 10:1, from about 5:1 to about 9:1, from about 5:1 to about 8:1 or from about 5:1 to about 7:1. For instance, the weight ratio of α-hydroxy ketone to bisacylphosphine oxide is from about 7:1 to about 15:1, from about 8:1 to about 15:1, from about 9:1 to about 15:1, from about 10:1 to about 15:1, or from about 12:1 to about 15:1. For example, the weight ratio of α-hydroxy ketone to bisacylphosphine oxide is from about 7:1 to about 12:1, or from about 8:1 to about 11:1.

Efficient curing of the present coatings is possible with α-hydroxy ketone photoinitiators alone.

The ethylenically unsaturated polymerizable compounds can contain one or more than one olefinic double bond. They may be low molecular (monomeric) or high molecular (oligomeric) compounds.

Typical examples of monomers containing one double bond are alkyl or hydroxyalkyl acrylates or methacrylates, for example methyl, ethyl, butyl, 2-ethylhexyl and 2-hydroxyethyl acrylate, isobornyl acrylate, and methyl and ethyl methacrylate. Further examples of these monomers are acrylonitrile, acrylamide, methacrylamide, N-substituted (meth)acrylamides, vinyl esters such as vinyl acetate, vinyl ethers such as isobutyl vinyl ether, styrene, alkylstyrenes, halostyrenes, N-vinylpyrrolidone, vinyl chloride and vinylidene chloride.

Examples of monomers containing more than one double bond are ethylene glycol diacrylate, propylene glycol diacrylate, neopentyl glycol diacrylate, hexamethylene glycol diacrylate, bisphenol A diacrylate, 4,4′-bis(2-acryloyloxyethoxy)diphenylpropane, trimethylolpropane triacrylate, pentaerythritol triacrylate and tetraacrylate, pentaerythritol divinyl ether, vinyl acrylate, divinyl benzene, divinyl succinate, diallyl phthalate, triallyl phosphate, triallyl isocyanurate or tris(2-acryloylethyl)isocyanurate. Examples of high molecular weight (oligomeric) polyunsaturated compounds are acrylated epoxy resins, acrylated polyethers, acrylated polyurethanes and acrylated polyesters. Further examples of unsaturated oligomers are unsaturated polyester resins, which are usually prepared from maleic acid, phthalic acid and one or more diols and which have molecular weights of greater than about 500. Unsaturated oligomers of this type are also known as prepolymers.

Typical examples of unsaturated compounds are esters of ethylenically unsaturated carboxylic acids and polyols or polyepoxides, and polymers containing ethylenically unsaturated groups in the chain or in side groups, including unsaturated polyesters, polyamides and polyurethanes and copolymers thereof, polybutadiene and butadiene copolymers, polyisoprene and isoprene copolymers, polymers and copolymers containing (meth)acrylic groups in side-chains, as well as mixtures of one or more than one such polymer.

Illustrative examples of unsaturated carboxylic acids are acrylic acid, methacrylic acid, crotonic acid, itaconic acid, cinnamic acid, unsaturated fatty acids such as linolenic acid or oleic acid.

Suitable polyols are aromatic, aliphatic and cycloaliphatic polyols. Aromatic polyols are typically hydroquinone, 4,4′-dihydroxydiphenyl, 2,2-bis(4-hydroxyphenyl)propane, as well as novolacs and cresols. Polyepoxides include those based on the cited polyols, for instance on the aromatic polyols and epichlorohydrin. Further suitable polyols are polymers and copolymers which contain hydroxyl groups in the polymer chain or in side groups, for example polyvinyl alcohol and copolymers thereof or hydroxyalkyl polymethacrylates or copolymers thereof. Other suitable polyols are oligoesters carrying hydroxyl end groups.

Illustrative examples of aliphatic and cycloaliphatic polyols are alkylenediols containing for example 2 to 12 carbon atoms, including ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of for instance 200 to 1500, 1,3-cyclopentanediol, 1,2-, 1,3-or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be esterified partially or completely with one or with different unsaturated carboxylic acids, in which case the free hydroxyl groups of the partial esters may be modified, for example etherified, or esterified with other carboxylic acids.

Illustrative examples of esters are: Trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentacrylate, dipentaerythritol hexacrylate, tripentaerythritol octacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentacrylate, sorbitol hexacrylate, oligoester acrylates and methacrylates, glycerol di- and-riacrylate, 1,4-cyclohexanediacrylate, bisacrylates and bismethacrylates of polyethylene glycol having molecular weights of 200 to 1500, or mixtures thereof. Polyfunctional monomers and oligomers are available for example from UCB Chemicals, Smyrna, Ga., and Sartomer, Exton, Pa.

Suitable ethylenically unsaturated polymerizable compounds are also the amides of identical or different unsaturated carboxylic acids of aromatic, cycloaliphatic and aliphatic polyamines containing for instance 2 to 6, for example 2 to 4, amino groups. Exemplary of such polyamines are ethylenediamine, 1,2- or 1,3-propylenediamine, 1,2-, 1,3-or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, bis(β-aminoethyl) ether, diethylenetriamine, triethylenetetramine, bis(ε-aminoethoxy)ethane or bis(β-aminopropoxy)ethane. Other suitable polyamines are polymers and copolymers which may contain additional amino groups in the side-chain and oligoamides containing amino end groups.

Exemplary of such unsaturated amides are: Methylenebisacrylamide, 1,6-hexamethylenebisacrylamide, diethylenetriaminetrismethacrylamide, bis(methacrylamidopropoxy)ethane, p-methacrylamidoethylmethacrylate, N-[(β-hydroxyethoxy)ethyl]acrylamide.

Suitable unsaturated polyesters and polyamides are derived typically from maleic acid and diols or diamines. Maleic acid can be partially replaced by other dicarboxylic acids such as fumaric acid, itaconic acid, citraconic acid, mesaconic acid or chloromaleic acid. To control the reactivity of the polyester and to influence the crosslinking density and hence the product properties, it is possible to use in addition to the unsaturated dicarboxylic acids different amounts of saturated dicarboxylic acids such as phthalic acid, isophthalic acid, terephthalic acid, tetrahydrophthalic acid, succinic acid or adipic acid. The unsaturated polyesters can be used together with ethylenically unsaturated comonomers such as styrene. The polyesters and polyamides can also be derived from dicarboxylic acids and ethylenically unsaturated diols or diamines, especially from those with long chains containing typically from 6 to 20 carbon atoms. Polyurethanes are typically those derived from saturated or unsaturated diisocyanates and unsaturated and saturated diols.

Suitable polyester acrylates or acrylated polyesters are obtained by reacting oligomers, typically epoxides, urethanes, polyethers or polyesters, with acrylates such as hydroxyethyl acrylate or hydroxypropyl acrylate.

Polybutadiene and polyisoprene and copolymers thereof are known. Suitable comonomers include olefins such as ethylene, propene, butene, hexene, (meth)acrylates, acrylonitrile, styrene or vinyl chloride. Polymers containing (meth)acrylate groups in the side-chain are also known. They may typically be reaction products of epoxy resins based on novolak with (meth)acrylic acid, homo- or copolymers of polyvinyl alcohol or their hydroxyalkyl derivatives which are esterified with (meth)acrylic acid or homo- and copolymers of (meth)acrylates which are esterified with hydroxyalkyl(meth)acrylates.

Monomers are for instance alkyl- or hydroxyalkyl acrylates or methacrylates, styrene, ethylene glycol diacrylate, propylene glycol diacrylate, neopentyl glycol diacrylate, hexamethylene glycol diacrylate or bisphenol A diacrylate, 4,4′-bis(2-acryloyloxyethoxy)diphenylpropane, trimethylolpropane triacrylate, pentaerythritol triacrylate or tetraacrylate, for instance acrylates, styrene, hexamethylene glycol or bisphenol A diacrylate, 4,4′-bis(2-acryloyloxyethoxy)diphenylpropane or trimethylolpropane triacrylate.

Oligomeric polyunsaturated compounds are for instance polyester acrylates or unsaturated polyester resins which are prepared from maleic acid, fumaric acid, phthalic acid and one or more than one diol, and which typically have molecular weights from about 500 to 3000.

Unsaturated carboxylic acids are for example acrylic acid and methacrylic acid.

The photopolymerizable compounds are used by themselves or in any desired mixtures. It is suitable to use mixtures of polyol(meth)acrylates.

Binders may also be added to the unsaturated photopolymerizable compounds. The addition of binders is particularly useful if the photopolymerizable compounds are liquid or viscous substances. The amount of binder may be from 5-95, for example 10-90, for instance 40-90, percent by weight, based on the entire composition. The choice of binder will depend on the field of use and the desired properties therefore, such as the ability of the compositions to be developed in aqueous and organic solvent systems, adhesion to substrates and susceptibility to oxygen.

Suitable binders are typically polymers having a molecular weight of about 5,000 to 2,000,000, for instance 10,000 to 1,000,000. Illustrative examples are: Homo- and copolymers of acrylates and methacrylates, including copolymers of methyl methacrylate/ethyl acrylate/methacrylic acid, poly(alkylmethacrylates), poly(alkylacrylates); cellulose esters and ethers such as cellulose acetate, cellulose acetobutyrate, methyl cellulose, ethyl cellulose; polyvinyl butyral, polyvinyl formal, cyclized rubber, polyethers such as polyethylene oxide, polypropylene oxide, polytetrahydrofuran; polystyrene, polycarbonate, polyurethane, chlorinated polyolefins, polyvinyl chloride, copolymers of vinyl chloride/vinylidene chloride, copolymers of vinylidene chloride with acrylonitrile, methyl methacrylate and vinyl acetate, polyvinyl acetate, copoly(ethylene/vinyl acetate), polymers such as polycaprolactam and poly(hexamethylene adipamide), polyesters such as poly(ethylene glycol terephthalate) and poly(hexamethylene glycol succinate).

The unsaturated compounds can also be used in admixture with non-photopolymerizable film-forming components. These components may be physically drying polymers or solutions thereof in organic solvents, for example nitrocellulose or cellulose acetobutyrate. The photopolymerizable unsaturated monomers may be a component of a free radical-ionic curable blend, such as a free radical-cationic curable blend. Also of importance are systems that undergo both thermal and photo-induced curing cycles, such as are used in powder coatings, laminates, certain adhesives and conformal coatings.

Mixtures of a prepolymer with polyunsaturated monomers which, additionally contain a further unsaturated monomer are frequently used in paint systems. The prepolymer in this instance primarily determines the properties of the paint film and, by varying it, the skilled person can influence the properties of the cured film. The polyunsaturated monomer acts as crosslinking agent that renders the paint film insoluble. The mono-unsaturated monomer acts as reactive diluent with the aid of which the viscosity is lowered without having to use a solvent. Moreover, properties of the cured composition such as curing rate, crosslinking density and surface properties are dependent on the choice of monomer.

Unsaturated polyester resins are usually used in two-component systems, together with a mono-unsaturated monomer, for example with styrene.

Binary electron-rich/electron-poor monomer systems are often employed in thick pigmented coatings. For example, vinyl ether/unsaturated polyester systems are employed in powder coatings and styrene/unsaturated polyester systems are used in gel coats.

A suitable process is that wherein the ethylenically unsaturated polymerizable compounds are a mixture of at least one oligomeric compound and at least one monomer.

An interesting process is that wherein the ethylenically unsaturated polymerizable compounds are a mixture of 1) unsaturated polyesters, especially those that are prepared from maleic acid, fumaric acid and/or phthalic acid and one or more than one diol, and which have molecular weights of 500 to 3,000, and 2) acrylates, methacrylates or styrene or combinations thereof.

An important process is also that wherein the ethylenically unsaturated polymerizable compounds are a mixture of 1) unsaturated polyesters and 2) acrylates or methacrylates or combinations thereof.

Another interesting process is that wherein the ethylenically unsaturated polymerizable compounds are a mixture of 1) unsaturated polyester acrylates and 2) acrylates or methacrylates or combinations thereof.

The present photopolymerizable coating compositions may additionally contain further additives. Examples thereof are thermal inhibitors, which are intended to prevent premature polymerization, for example hydroquinone, hydroquinone derivatives, p-methoxyphenol, β-naphthol or sterically hindered phenols such as 2,6-di(tert-butyl)-p-cresol. To enhance the dark storage stability it is possible to add copper compounds, including copper naphthenate, copper stearate or copper octoate, phosphorus compounds, including triphenylphosphine, tributylphosphine, triethyl phosphite, triphenyl phosphite, or tribenzyl phosphite, quaternary ammonium compounds, such as tetramethylammonium chloride or trimethylbenzylammonium chloride, or hydroxylamine derivatives, such as N-diethylhydroxylamine. The exclusion of atmospheric oxygen during the polymerization may be effected by adding paraffin or similar wax-like substances which, at the onset of polymerization, migrate to the surface owing to lack of solubility in the polymer and form a transparent film which prevents air from entering the system. Similarly, an oxygen-impermeable layer may be applied. UV absorbers, typically those of the hydroxyphenylbenzotriazole, hydroxyphenylbenzophenone, oxanilide or hydroxyphenyl-s-triazine type, or combinations thereof, may be added as light stabilizers. It may be advantageous to add light stabilizers that do not absorb UV light, for example those of the sterically hindered amine (HALS) class. The light stabilizers selected from the classes of UV absorbers or HALS may be employed separately or in any combination.

Examples of such standard UV absorbers and light stabilizers are:

1. 2-(2-Hydroxyyhenyl)benzotriazoles, for example 2-(2-hydroxy-5-methylphenyl)-benzotriazole, 2-(3,5-di-ert-butyl-2-hydroxyphenyl)benzotriazole, 2-(5-tert-butyl-2-hydroxyphenyl)benzotriazole, 2-(2-hydroxy-5-(1,1,3,3-tetramethylbutyl)phenyl)benzotriazole, 2-(3,5-di-tert-butyl-2-hydroxyphenyl)-5-chloro-benzotriazole, 2-(3-tert-butyl-2-hydroxy-5-methylphenyl)-5-chloro-benzotriazole, 2-(3-sec-butyl-5-tert-butyl-2-hydroxyphenyl)benzotriazole, 2-(2-hydroxy-4-octyloxyphenyl)benzotriazole, 2-(3,5-di-tert-amyl-2-hydroxyphenyl)benzotriazole, 2-(3,5-bis-(α,α-dimethylbenzyl)-2-hydroxyphenyl)benzotriazole, 2-(3-tert-butyl-2-hydroxy-5-(2-octyloxycarbonylethyl)phenyl)-5-chloro-benzotriazole, 2-(3-tert-butyl-5-[2-(2-ethylhexyloxy)-carbonylethyl]-2-hydroxyphenyl)-5-chloro-benzotriazole, 2-(3-tert-butyl-2-hydroxy-5-(2-methoxycarbonylethyl)phenyl)-5-chloro-benzotriazole, 2-(3-tert-butyl-2-hydroxy-5-(2-methoxy-carbonylethyl)phenyl)benzotriazole, 2-(3-tert-butyl-2-hydroxy-5-(2-octyloxycarbonylethyl)-phenyl)benzotriazole, 2-(3-tert-butyl-5-[2-(2-ethylhexyloxy)carbonylethyl]-2-hydroxyphenyl)benzotriazole, 2-(3-dodecyl-2-hydroxy-5-methylphenyl)benzotriazole, 2-(3-tert-butyl-2-hydroxy-5-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3-tert-butyl-5-(2-methoxycarbonylethyl)-2-hydroxyphenyl]-2H-benzotriazole with polyethylene glycol 300; [R—CH₂CH₂—COO—CH₂CH₂—] where R=3′-tert-butyl4′-hydroxy-5′-2H-benzotriazol-2-ylphenyl, 2-[2-hydroxy-3-(α,α-dimethylbenzyl)-5-(1,1,3,3-tetramethylbutyl)-phenyl]benzotriazole; 2-[2-hydroxy-3-(1,1,3,3-tetramethylbutyl)-5-(α,α-dimethylbenzyl)-phenyl]benzotriazole.

2. 2-Hvdroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

3. Esters of substituted and unsubstituted benzoic acids, as for example 4-tertbutyl-phenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxy-cinnamate, butyl α-cyano-β-methyl-p-methoxy-cinnamate, methyl α-carbomethoxy-p-methoxycinnamate and N-(β-carbomethoxy-β-cyanovinyl)-2-methylindoline.

5. Sterically hindered amines, for example bis(2,2,6,6-tetramethyl-4-piperidyl) sebacate, bis(2,2,6,6-tetramethyl4-piperidyl) succinate, bis(1,2,2,6,6-pentamethyl4-piperidyl) sebacate, bis(1-octyloxy-2,2,6,6-tetramethyl-4-piperidyl) sebacate, bis(1,2,2,6,6-pentamethyl4-piperidyl) n-butyl-3,5-di-ert-butyl4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl4-piperidyl)hexamethylenediamine and 4-tert-octylamino-2,6-dichloro-1,3,5-triazine, tris(2,2,6,6-tetramethyl-4-piperidyl) nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-ditert-butylbenzyl) malonate, 3-n-octyl-7,7,9,9-tetramethyl-1,3,8-triazaspiro[4.5]decan-2,4-dione, bis(1-octyloxy-2,2,6,6-tetramethylpiperidyl) sebacate, bis(1-octyloxy-2,2,6,6-tetramethylpiperidyl) succinate, linear or cyclic condensates of N,N′-bis-(2,2,6,6-tetramethyl4-piperidyl)-hexamethylenediamine and 4-morpholino-2,6-dichloro-1,3,5-triazine, the condensate of 2-chloro4,6-bis(4-n-butylamino-2,2,6,6-tetramethylpiperidyl)-1,3,5-triazine and 1,2-bis(3-amino-propylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-riazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza4-oxospiro [4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl4-piperidyl)hexamethylenediamine, diester of 4-methoxy-methylene-malonic acid with 1,2,2,6,6-pentamethyl4-hydroxypiperidine, poly[methylpropyl-3-oxy-4-(2,2,6,6-tetramethyl4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

6. Sterically hindered amines substituted on the N-atom by a hydroxy-substituted alkoxy groug, for example compounds such as 1-(2-hydroxy-2-methylpropoxy)₄-octadecanoyloxy-2,2,6,6-etramethylpiperidine, 1-(2-hydroxy-2-methylpropoxy)-4-hexadecanoyloxy-2,2,6,6-tetra-methylpiperidine, the reaction product of 1-oxyl-4-hydroxy-2,2,6,6-tetramethylpiperidine with a carbon radical from t-amylalcohol, 1-(2-hydroxy-2-methylpropoxy)₄-hydroxy-2,2,6,6-tetra-methylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl) sebacate, bis(1-(2-hydroxy-2-methylpropoxy)-2,2,6,6-tetramethylpiperidin-4-yl) adipate, bis(1-(2-hydroxy-2-methylpropoxy)-2,2,6,6-tetramethylpiperidin-4-yl) succinate, bis(1-(2-hydroxy-2-methylpropoxy)-2,2,6,6-tetra-methylpiperidin-4-yl) glutarate and 2,4-bis{N-[1-(2-hydroxy-2-methylpropoxy)-2,2,6,6-tetra-methylpiperidin-4-yl]-N-butylamino}6-(2-hydroxyethylamino)-s-triazine.

7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-riazine, 2-(2-hydroxy4-octyloxyphenyl)4,6-bis(4-methylphenyl)-1,3,5-triazine, 2-(2-hydroxy4-dodecyloxyphenyl)4,6-bis(2,4-dimethylphenyl)-1,3,5-triazine, 2-(2-hydroxy-4-tridecyloxyphenyl)4,6-bis(2,4-dimethylphenyl)-1,3,5-triazine, 2-[2-hydroxy-4-(2-hydroxy-3-butyloxypropoxy)phenyl]4,6-bis(2,4-dimethylphenyl)-1,3,5-triazine, 2-[2-hydroxy-4-(2-hydroxy-3-octyloxy-propyloxy)phenyl]-4,6-bis(2,4-dimethylphenyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy4-(2-hydroxy-3-dodecyloxy-propoxy)phenyl]-4,6-bis(2,4-dimethylphenyl)-1,3,5-triazine, 2-(2-hydroxy4-hexyloxy)phenyl-4,6-diphenyl-1,3,5-triazine, 2-(2-hydroxy4-methoxyphenyl)4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy4-[3-(2-ethylhexyl-1-oxy)-2-hydroxypropyloxy]phenyl}-4,6-bis(2,4-dimethylphenyl)-1,3,5-triazine, 4,6-bis(2,4-dimethylphenyl)-2-[2-hydroxy4-(2-hydroxy-3-nonyloxypropoxy)-5-(1-methyl-1-phenylethyl)phenyl]-1,3,5-triazine.

9. Phosphites and phosphonites, for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-dibenzo[d,f][1,3,2]dioxaphosphepin, 6-fluoro-2,4,8,10-tetra-tert-butyl-12-methyl-dibenzo[d,g][1,3,2]dioxaphosphocin, bis(2,4-di-tert-butyl-6-methylphenyl) methyl phosphite, bis(2,4-di-tert-butyl-6-methylphenyl) ethyl phosphite, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite.

Additionally, there may be employed in the processes and compositions of this invention additives selected from the classes of fillers, flow aids, adhesion promoters, rheological modifiers such as fumed silica, pigments, dyes, optical brighteners, wetting agents and surfactants, among others.

Advantageously, a mixture of more than one of present hydroxyphenylbenzotriazoles may be employed. Another specific embodiment is where additional additives selected from the group consisting of hydroxyphenyltriazine UV absorbers and hindered amine light stabilizers are employed. Hindered amine light stabilizers is a generic term that encompasses sterically hindered amine additives with any substitution on the N atom, for example alkoxy and hydroxy-substituted alkoxy groups.

The thickness of the coating films (dry film thickness) of the present invention are for example from about 0.2 mil to about 5 mil. For instance, the present dry (cured) film thicknesses are from about 0.2 mil to about 4 mil, from about 0.2 mil to about 3 mil, from about 0.2 mil to about 2 mil, or from about 0.2 mil to about 1 mil. For example, the present dry film thicknesses are from about 0.5 mil to about 5 ml, from about 1 mil to about 5 ml, from about 2 mil to about 5 ml, from about 3 mil to about 5 mil, or from about 4 mil to about 5 mil. For example, the present dry coating film thicknesses are from about 0.5 mil to about 3.5 ml, or from about 1 mil to about 2.5 mil.

The films prepared according to this invention are advantageously employed for example as window films, in graphic overcoating, as solar control films, as backlit display films, as overlaminate films (exterior or interior digital graphics and the like), in signage, in laminated glazing, ink jet media coatings, in electrochromic/photochromic applications, optical light films, in safety glass/windshield interlayers, in-mold films, decals, anti-grafitti films, specialty packaging, compact disc coatings, protective coatings for polymer substrates (e.g. for plastic parts such as machine and automobile parts), and other high-performance thin coating applications.

The present films are especially effective towards preventing the underlying substrate against the deleterious effects of UV radiation. For example, they are especially effective towards the protection of dyes or pigments present in underlying substrates against color fade.

The substrate surface can be coated by applying to said substrate a liquid composition, a solution or suspension. The choice of solvent and the concentration will depend mainly on the type of formulation and on the coating method employed. The solvent should be inert; in other words it should not undergo any chemical reaction with the components and should be capable of being removed again after the coating operation, in the drying process. Examples of suitable solvents are ketones, ethers and esters, such as methyl ethyl ketone, isobutyl methyl ketone, cyclopentanone, cyclohexanone, N-methylpyrrolidone, dioxane, tetrahydrofuran, 2-methoxyethanol, 2-ethoxyethanol, 1-methoxy-2-propanol, 1,2-dimethoxyethane, ethyl acetate, n-butyl acetate and ethyl 3-ethoxypropionate. The suspension is uniformly applied to a substrate by known coating techniques such as by spin coating, dip coating, curtain coating, knife coating, brushing or spraying or reverse roll coating. It is also possible to apply the photosensitive layer to a temporary, flexible support and then to coat the final substrate, for example a copper-laminated circuit board, by means of layer transfer via lamination.

The present method may additionally be employed for radiation-curable powder coatings. The powder coatings can be based on solid resins and on monomers containing reactive double bonds, for example maleates, vinyl ethers, acrylates, acrylamides and mixtures thereof. A free-radically UV-curable powder coating can be formulated by mixing unsaturated polyester resins with solid acrylamides (e.g. methyl methacrylamidoglycolate) and with a free-radical photoinitiator system according to the invention, as described, for example, in the paper “Radiation Curing of Powder Coating”, Conference Proceedings, Radtech Europe 1993 by M. Wittig and Th. Gohmann. Similarly, free-radically UV-curable powder coatings can be formulated by mixing unsaturated polyester resins with solid acrylates, methacrylates or vinyl ethers and with a photoinitiator system according to the invention. The powder coatings may also comprise binders as described, for example, in DE-A4228514 and EP-A-636669. The UV-curable powder coatings may also comprise white or colored pigments. Thus, for example, rutile titanium dioxide can be employed in concentrations of up to 50% by weight in order to give a cured powder coating having good covering power. The process normally comprises electrostatic or tribostatic spraying of the powder onto the substrate, for example metal or wood, melting of the powder by heating and, after a smooth film has been formed, radiation-curing of the coating using ultraviolet and/or visible light, for example with medium-pressure mercury lamps, metal halide lamps or xenon lamps. A particular advantage of the radiation-curable powder coatings over their heat-curable counterparts is that the flow time after the melting of the powder particles can be selectively extended in order to ensure the formation of a smooth, high-gloss coating. In contrast to heat-curable systems, radiation-curable powder coatings can be formulated without the unwanted effect of a reduction in their lifetime, so that they melt at relatively low temperatures. For this reason, they are also suitable as coatings for heat-sensitive substrates such as wood or plastics. In addition to the photoinitiator systems according to the invention, the powder coating formulations may also include UV absorbers. Appropriate examples have been listed above under sections 1.-8.

The photosensitivity of the compositions according to the invention generally ranges from the UV region (about 200 nm) up to about 600 nm. Suitable radiation comprises, for example, sunlight or light from artificial sources. Therefore, a large number of very different types of light source can be used. Both point sources and flat radiators (lamp carpets) are appropriate. Examples are carbon arc lamps, xenon arc lamps, medium-pressure, high-pressure and low-pressure mercury lamps, doped with metal halides if desired (metal halogen lamps), microwave-stimulated metal vapor lamps, excimer lamps, superactinic fluorescent tubes, fluorescent lamps, incandescent argon lamps, electronic flashlights, photographic flood lamps, electron beams and X-rays. For example, Hg lamps, iron doped Hg lamps or Ga doped Hg lamps are suitable. Artificial light sources equivalent to daylight may be used, such as low intensity lamps such as specific fluorescent lamps, e.g. Philips TL05 or TL09 special fluorescent lamps. The distance between the lamp and the substrate according to the invention which is to be coated can vary depending on the application and on the type and/or power of the lamp, for example between 2 cm and 150 cm. Also suitable, for example, are lasers in the visible range. The cure may be effected behind a transparent layer (e.g. a pane of glass or plastic sheet).

Complicated and expensive apparatus is superfluous when using light sources that emit light of low intensity, and the compositions in this case can be used in particular for special exterior applications. The cure with daylight or with light sources equivalent to daylight is an alternative to the standard moving belt method of UV curing. In contrast to the moving belt method, which is particularly suitable for flat parts, the daylight cure can be used for exterior coatings on stationary and fixed objects or constructions. These are typically coatings on buildings, facades, bridges, ships or markings on roads and sites as disclosed, inter alia, in EP-A-160723.

The cure with daylight or with light sources equivalent to daylight is an energy-saving method and, in exterior applications, no emission of volatile organic components into the environment occurs. The cure with daylight or light sources equivalent to daylight is, however, also suitable for series curing in which the objects are so positioned that angular areas are also exposed to daylight. In this connection, mirrors or reflectors can also be used.

The curable compositions are also a subject of this invention. Accordingly, further disclosed is a photo-curable coating composition, wherein said coating composition comprises

a) at least one ethylenically unsaturated polymerizable compound,

b) at least one durable and/or red-shifted hydroxyphenylbenzotriazole UV absorber and

c) a combination of photoinitiators comprising

i) at least one a-hydroxy ketone photoinitiator and

ii) at least one bisacylphosphine oxide photoinitiator.

The following Examples are for illustrative purposes and do not limit the present invention in any manner whatsoever.

### EXAMPLE 1

### UV Absorption Spectra In Solution

The instant benzotriazoles have different electron withdrawing substituents in the 5-position of the benzo ring of the benzotriazole and with different substitutions on the phenyl ring at the 3- and 5-positions. The UV absorption spectra are measured in ethyl acetate at approximately 20 mg/L concentration. The instant compounds are clearly red-shifted as compared to a compound having only hydrogen at the 5-position of the benzo ring.

| | | Absorbance |
|---|---|---|
| Compound | λmax (nm) | at 375 nm |
| A | 343 | 0.22 |
| B | 354 | 0.36 |

Compound A is octyl 3-(2H-benzotrizol-2-yl)-5-tert-butyl-4-hydroxyhydrocinnamate Compound B is 2-(1-Methyl-1-phenyl-ethyl)-4-(1,1,3,3-tetramethyl-butyl)-6-(5-trifluoromethyl-benzotriazol-2-yl)-phenol

### EXAMPLE 2

UV Curable Formulation

Urethane acrylate oligomer (20 g, Bomar, BR 5824), ethoxylated bisphenol A diacrylate (20 g, Sartomer, SR 601), propoxylated trimethylol propane triacrylate (32 g, Sartomer, SR492), di-trimethylolpropane tetraacrylate (25 g, Sartomer, SR 355), bis (2,4,6-trimethylbenzoyl)-phenylphosphine oxide (0.33 g, Ciba, Irgacure® 819), 1-hydroxycyclohexylphenyl ketone (2.67 g, Ciba, Irgacure® 184), and, optionally, an instant benzotriazole (3 g, 3% based on formulation weight) are added to a laboratory reactor equipped with the necessary auxiliary equipment. The mixture is agitated and heated gently to 50-80° C. for one hour after which the mass is cooled to ambient temperature and agitated for an additional hour.

UV Cured Film Preparation

2 mil (50 micron) thick films are prepared by applying the acrylate resin to glass plates using a Bird Film applicator, followed by UV light exposure under a nitrogen environment on a Fusion conveyer belt system (Fusion UV model DRS-10/12 conveyer system with nitrogen inerting capability). The lamp is a Fusion VPS/I600 (F600 series) irradiator that is equipped with a “D-lamp” (Fe doped mercury lamp bulb). A trace oxygen analyzer (Alpha Omega Instruments, model Series 2000) is used to measure O₂ levels during light curing. Under a nitrogen purge and at 50 ft/min conveyer belt speed, the oxygen levels are typically <200 ppm.

The VPS 600 unit is operated at variable voltage settings, which provides control over the light output intensity. The belt speed is maintained at a rate of 50 ft/min throughout all operations.

### EXAMPLE 3

### MEK Double Rub Test

The solvent resistance is determined using a MEK (methyl ethyl ketone) double rub test. This procedure is found in: Z. Jovanovic et al Verfkroniek 2001, 74(11), 29-32. The number of double rubs required to break or mar the surface of the coating is measured using a Crockmeter (Am. Assoc. of Textile Chemist Colorants, U.S. Pat. No. 2,114,831).

The MEK double rub is correlated to the solvent resistance and increases with the degree of cure. The degree of cure is related to the amount of light used to activate the photoinitiator. In general, the MEK double value is an increasing function of light dose and reaches a certain plateau value. A maximum of 100 MEK double rubs are interpreted as full cure for these coating, i.e., the solvent resistance is independent of the light dose when the MEK values of 100 or greater are obtained.

| | | MEK Rub | MEK Rub |
|---|---|---|---|
| | Dose | Test Results | Test Results |
| Power(P) | mJ/cm² | No UVA | 3% Compound B |
| 30% P | 16 | 75 | <10 |
| 40% P | 85 | 75 | 75 |
| 50% P | 192.3 | 75 | 75 |
| 60% P | 323 | >100 | >100 |
| 100% P | 829 | >100 | >100 |
| 2 passes | 1658 | >100 | >100 |
| at 100% P | | | |

UVA = Ultraviolet light absorber
Compound B is 2-(1-methyl-1-phenyl-ethyl)-4-(1,1,3,3-tetramethyl-butyl)-6-(5-trifluoromethyl-benzotriazol-2-yl)-phenol

This demonstrates that the coating is readily cured in the presence of a red-shifted benzotriazole and it is not detrimental to the cure rate or cure speed.

### EXAMPLE 4

### Thumb-Twist Test

The thumb-twist test is used to assess the degree of cure and is a pass-fail test. The reference for this test is located in: C. Lowe, Volume VI, Test methods for UV & EB Curable Systems, p. 74 (Wiley/SITA Series in Surface Coatings Technology, SITA Technology Limited, 1996). It is carried out on a series of coatings that are exposed to increasingly higher amounts of UV dose. A failure is when the thumb-twist produces surface mar, which indicates the coating is undercured. The dose needed to pass the thumb-twist is when no surface mar occurs.

| | Dose | | |
|---|---|---|---|
| Power(P) | mJ/cm² | No UVA | 3% Compound B |
| 30% P | 16 | Fail | Fail |
| 40% P | 85 | Pass | Pass |
| 50% P | 192.3 | Pass | Pass |
| 60% P | 323 | Pass | Pass |
| 100% P | 829 | Pass | Pass |
| 2 passes | 1658 | Pass | Pass |
| at 100% P | | | |

UVA = Ultraviolet light absorber
Compound B is 2-(1-methyl-1-phenyl-ethyl)-4-(1,1,3,3-tetramethyl-butyl)-6-(5-trifluoromethyl-benzotriazol-2-yl)-phenol

This further demonstrates that the coating is readily cured in the presence of a red-shifted benzotriazole and it is not detrimental to the cure rate or cure speed.

### EXAMPLE 5

### UV Stability and Photo-Bleaching Resistance

UV absorption spectra are taken of the cured films to determine whether photo-bleaching of the UV absorber had occurs during UV curing. Little to no change in optical density is highly desired.

| | Dose | Wavelength | |
|---|---|---|---|
| Power(P) | mJ/cm² | (nm) | Optical Density (OD) |
| 40% P | 85 | 398 | 0.99 |
| 100% P | 829 | 398 | 1.01 |
| 16 passes | 13264 | 398 | 0.93 |
| at 100% P | | | |

Each formulation contains 3% by weight of 2-(1-Methyl-1-phenyl-ethyl)-4-(1,1,3,3-tetramethyl-butyl)-6-(5-trifluoromethyl-benzotriazol-2-yl)-phenol

The absorption occurring from the UV absorber (optical density) is within experimental error and invariant to the light dose. The fact that no change occurred in the UV absorption spectra of the UV absorbers in the cured coatings demonstrate that the instant compounds can survive the UV exposure conditions. Furthermore, it is found that no photo-fading of these compounds occurred even at very high light exposures (>13 J/cm²). This result demonstrates that the instant compounds could also be used in photo-curable coatings that require higher exposures than the one under current study.

### EXAMPLE 6

Examples 2-5 are repeated, with the further inclusion of 1% weight percent of a hindered amine light stabilizer, for example Tinuvin® 123, bis(1-octyloxy-2,2,6,6-tetramethyl-4-piperidyl) sebacate, available from Ciba Specialty Chemicals. Excellent results are achieved.

### EXAMPLE 7

Examples 2-6 are repeated, where the UVA is replaced with a 1:1 mixture of two hydroxyphenylbenzotriazoles or a 1:1 mixture of a hydroxyphenylbenzotriazole and a hydroxyphenyltriazine. For example, 1:1 mixtures of

2-(1-methyl-1-phenyl-ethyl)-4-(1,1,3,3-tetramethyl-butyl)-6-(5-trifluoromethyl-benzotriazol-2-yl)-phenol and 2-(1-methyl-1-phenyl-ethyl)₄-(1,1,3,3-tetramethyl-butyl)-6-(benzotriazol-2-yl)-phenol or

2-(1-methyl-1-phenyl-ethyl)-4-(1,1,3,3-tetramethyl-butyl)-6-(5-trifluoromethyl-benzotriazol-2-yl)-phenol and 2-[4-(dodecyloxy/tridecyloxy-2-hydroxypropoxy)-2-hydroxyphenyl]4,6-bis(2,4-dimethylphenyl) 1,3,5-triazine.

Excellent results are achieved.

What is claimed is:

1. A process for forming a protective film coating
which process comprises curing a coating composition by irradiating said composition with ultraviolet radiation or daylight or with light sources equivalent to daylight,
wherein said coating composition comprises
a) at least one ethylenically unsaturated polymerizable compound,
b) at least one durable and/or red-shifted hydroxyphenylbenzotriazole UV absorber and
c) a combination of photoinitiators comprising
i) at least one α-hydroxy ketone photoinitiator and
ii) at least one bisacylphosphine oxide photoinitiator,
wherein the hydroxyphenylbenzotriazoles of component b) are of the formula 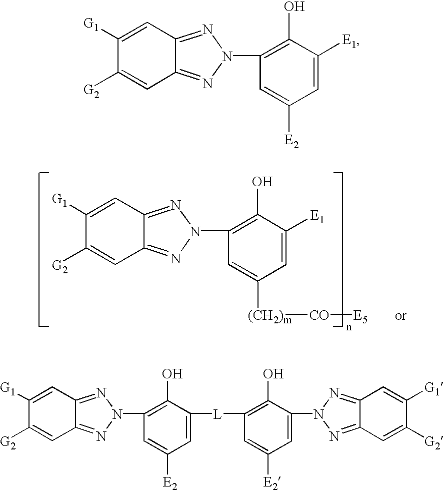
wherein
G₁ and G₁′ are independently hydrogen or halogen,
G₂ and G₂′ are independently halogen, nitro, cyano, perfluoroalkyl of 1 to 12 carbon atoms, —COOG₃, —P(O)(C₆H₅)₂, —CO-G₃, —CO—NH-G₃, —CO—N(G₃)₂, —N(G₃)—CO-G₃, E₃SO— or E₃SO₂—; or G₂′ is also hydrogen,
G₃ is hydrogen, straight or branched chain alkyl of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms,
E₁ is hydrogen, straight or branched chain alkyl of 1 to 24 carbon atoms, straight or branched chain alkenyl of 2 to 24 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms; or E₁ is alkyl of 1 to 24 carbon atoms substituted by one or two hydroxy groups,
when E₁ is phenylalkyl of 7 to 15 carbon atoms or phenyl, or said phenyl or said phenylalkyl substituted on the phenyl ring by 1 to 4 alkyl of 1 to 4 carbon atoms, G₂ may also be hydrogen,
E₂ and E₂′ are independently straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by one to three alkyl of 1 to 4 carbon atoms; or E₂ and E₂′ are independently said alkyl of 1 to 24 carbon atoms or said alkenyl of 2 to 18 carbon atoms substituted by one or more —OH, —OCOE₁₁, —OE₄, —NCO, —NH₂, —NHCOE₁₁, —NHE₄ or —N(E₄)₂, or mixtures thereof, where E₄ is straight or branched chain alkyl of 1 to 24 carbon atoms; or said alkyl or said alkenyl interrupted by one or more —O—, —NH— or —NE₄— groups or mixtures thereof and which can be unsubstituted or substituted by one or more —OH, —OE₄ or —NH₂ groups or mixtures thereof,
E₃ is alkyl of 1 to 20 carbon atoms, hydroxyalkyl of 2 to 20 carbon atoms, alkyl substituted by alkoxycarbonyl of 2 to 9 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms,
n is 1 or 2,
when n is 1,
E₅ is OE₆ or NE₇E₈, or E₅ is —PO(OE₁₂)₂, —OSi(E₁₁)₃ or —OCO-E₁₁, or straight or branched chain C₁-C₂₄alkyl which is interrupted by —O—, —S— or —NE₁, and which can be unsubstituted or substituted by —OH or —OCO-E₁₁, C₅-C₁₂ cycloalkyl which is unsubstituted or substituted by —OH, straight chain or branched C₂-C₁₈alkenyl which is unsubstituted or substituted by —OH, C₇-C₁₅aralkyl, —CH₂—CHOH-E₁₃ or glycidyl,
or E₅ is —X-(Z)ₚ—Y-E₁₅
where
X is —O— or —N(E₁₆)—,
Y is —O— or —N(E₁₇)—,
Z is C₂-C₁₂-alkylene, C₄-C₁₂-alkylene interrupted by one to three nitrogen atoms, oxygen atoms or a mixture thereof, or is C₃-C₁₂-alkylene, butenylene, butynylene, cyclohexylene or phenylene, each substituted by a hydroxyl group,
m is zero, 1 or 2,
p is 1, or p is also zero when X and Y are —N(E₁₆)— and —N(E₁₇)—, respectively,
E₆ is hydrogen, straight or branched chain C₁-C₂₄alkyl which is unsubstituted or substituted by one or more OH, OE₄ or NH₂ groups, or —OE₆ is —(OCH₂CH₂)_{w}OH or —(OCH₂CH₂)_{w}OE₂₁ where w is 1 to 12 and E₂₁ is alkyl of 1 to 12 carbon atoms,
E₇ and E₈ are independently hydrogen, alkyl of 1 to 18 carbon atoms, straight or branched chain C₃-C₁₈alkyl which is interrupted by —O—, —S— or —NE₁₁—, C₅-C₁₂cycloalkyl, C₆-C₁₄aryl or C₁-C₃hydroxylalkyl, or E₇ and E₈ together with the N atom are a pyrrolidine, piperidine, piperazine or morpholine ring,
E₉ is C₂-C₈alkylene, C₄-C₈alkenylene, C₄alkynylene, cyclohexylene, straight or branched chain C₄-C₁₀alkylene which is interrupted by —O— or by —CH₂—CHOH—CH₂—O-E₁₄-O—CH₂—CHOH—CH₂—,
E₁₀ being straight or branched chain C₂-C₁₂alkylene which may be interrupted by —O—, cyclohexylene, or 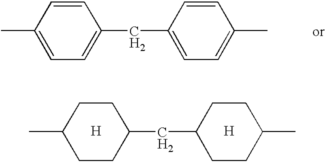
or E₁₀ and E₁₁ with the two nitrogen atoms form a piperazine ring,
E₁₁ is hydrogen, straight or branched chain C₁-C₁₈alkyl, C₅-C₁₂cycloalkyl, straight or branched chain C₂-C₁₈alkenyl, C₆-C₁₄aryl or C₇-C₁₅aralkyl,
E₁₂ is straight or branched chain C₁-C₁₈alkyl, straight or branched chain C₃-C₁₈alkenyl, C₅-C₁₀cycloalkyl, C₆-C₁₆aryl or C₇-C₁₅aralkyl,
E₁₃ is H, straight chain or branched C₁-C₁₈alkyl which is substituted by —PO(OE₁₂)₂, phenyl which is unsubstituted or substituted by OH, C₇-C₁₅aralkyl or —CH₂OE₁₂,
E₁₄ is straight or branched chain C₂-C₈alkylene, straight or branched chain C₄-C₁₀alkylene which is interrupted by —O—, cycloalkylene, arylene or 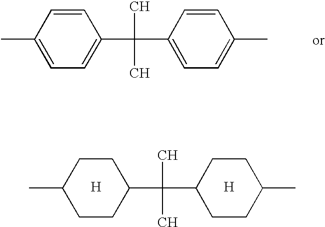
where E₇ and E₈ are independently hydrogen, alkyl of 1 to 18 carbon atoms or E₇ and E₈ together are alkylene of 4 to 6 carbon atoms, 3-oxapentamethylene, 3-iminopentamethylene or 3-methyliminopentamethylene,
E₁₅ is a group —CO—C(E₁₈)═C(H)E₁₉ or, when Y is —N(E₁₇)-, forms together with E₁₇ a group —CO—CH═CH—CO—, wherein E₁₈ is hydrogen or methyl, and E₁₉ is hydrogen, methyl or —CO—X-E₂₀, wherein E₂₀ is hydrogen, C₁-C₁₂-alkyl or a group of the formula 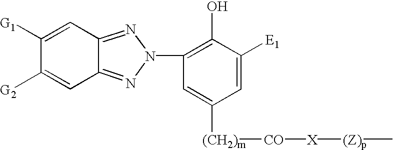
where E₁, G₂, X, Z, m and p are as defined above, and E₁₆ and E₁₇ independently of one another are hydrogen, C₁-C₁₂-alkyl, C₃-C₁₂-alkyl interrupted by 1 to 3 oxygen atoms, or is cyclohexyl or C₇-C₁₅aralkyl, and E₁₆ together with E₁₇ in the case where Z is ethylene, also forms ethylene and
L is alkylene of 1 to 12 carbon atoms, alkylidene of 2 to 12 carbon atoms, benzylidene, p-xylylene, α,α,α′,α′-tetramethyl-m-xylylene or cycloalkylidene and
when n is 2,
one of G₂ is also hydrogen and
E₅ is one of divalent radicals —O-E₉-O— or —N(E₁₁)-E₁₀-N(E₁₁)-,
wherein the α-hydroxy ketone photoinitiators of component i) are of the formula 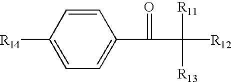
where:
R₁₁ and R₁₂ independently of one another are hydrogen, C₁-C₆ alkyl, phenyl, C₁-C₆ alkoxy, OSiR₁₆(R₁₇)₂ or —O(CH₂CH₂O)_{q}—C₁-C₆ alkly, or
R₁₁ and R₁₂, together with the carbon atom to which they are attached, form a cyclohexyl ring;
q is a number from 1 to 20;
R₁₃ is OH, C₁-C₁₆ alkoxy or —O(CH₂CH₂O)_{q}—C₁-C₆ alkyl;
R₁₄ is hydrogen, C₁-C₁₈ alkyl, C₁-C₁₈ alkoxy, —OCH₂CH₂—OR₁₅, a group CH₂═C(CH₃)— or 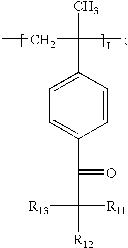
l is a number from 2 to 10;
R₁₅ is hydrogen, —COCH═CH₂ or —COC(CH₃)═CH₂; and
R₁₆ and R₁₇ independently of one another are C₁-C₈ alkyl or phenyl; and
wherein the bisacyiphosphine oxide photoinitiators of component ii) are of the formula 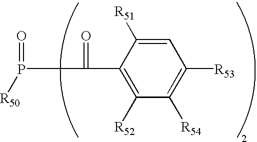
wherein
R₅₀ is C₁-C₁₂ alkyl, cyclohexyl or phenyl which is unsubstituted or is substituted by 1 to 4 halogen or C₁-C₈ alkyl,
R₅₁, and R₅₂ are each independently of the other C₁-C₈ alkyl,
R₅₃ is hydrogen or C₁-C₈ alkyl, and
R₅₄ is hydrogen or methyl.

2. A process according to claim 1 wherein the hydroxyphenylbenzotriazoles are of the formula 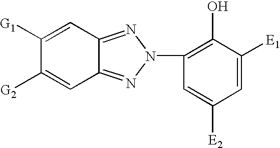
wherein
G₁ is hydrogen,
G₂ is hydrogen, cyano, chloro, fluoro, —CF₃, —CO-G₃, E₃SO— or E₃SO₂—,
G₃ is straight or branched chain alkyl of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms,
E₁ is phenylalkyl of 7 to 15 carbon atoms, phenyl, or said phenyl or said phenylalkyl substituted on the phenyl ring by 1 to 4 alkyl of 1 to 4 carbon atoms,
E₂ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or E₂ is said alkyl of 1 to 24 carbon atoms or said alkenyl of 2 to 18 carbon atoms substituted by one or more —OH, —OCOE₁₁, —OE₄, —NCO, —NH₂, —NHCOE₁₁, —NHE₄ or —N(E₄)₂, or mixtures thereof, where E₄ is straight or branched chain alkyl of 1 to 24 carbon atoms; or said alkyl or said alkenyl interrupted by one or more —O—, —NH— or —NE₄— groups or mixtures thereof and which can be unsubstituted or substituted by one or more —OH, —OE₄ or —NH₂ groups or mixtures thereof;
E₃ is alkyl of 1 to 20 carbon atoms, hydroxyalkyl of 2 to 20 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms;
or where
G₁ is hydrogen,
G₂ is chloro, fluoro, —CF₃, E₃SO— or E₃SO₂—,
E₁ is hydrogen or straight or branched alkyl of 1 to 24 carbon atoms,
E₂ is as defined above, and
E₃ is straight or branched chain alkyl of 1 to 7 carbon atoms.

3. A process according to claim 1 where the hydroxyphenylbenzotriazoles are of the formula 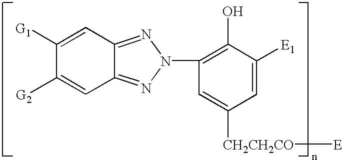
wherein
G₁ is hydrogen,
G₂ is —CF₃ or fluoro,
E₁ is hydrogen, straight or branched alkyl of 1 to 24 carbon atoms or phenylalkyl of 7 to 15 carbon atoms,
when E₁ is phenylalkyl of 7 to 15 carbon atoms, G₂ may also be hydrogen,
E₅ is —OE₆ or —NE₇E₈, or
E₅ is —X-(Z)ₚY-E₁₅
wherein
X is —O— or —N(E₁₆)—,
Y is —O— or —N(E₁₇)—,
Z is C₂-C₁₂-alkylene, C₄-C₁₂-alkylene interrupted by one to three nitrogen atoms, oxygen atoms or a mixture thereof, or is C₃-C₁₂-alkylene, butenylene, butynylene, cyclohexylene or phenylene, each substituted by a hydroxyl group,
m is 0, 1, 2 or 3,
p is 1, or p is also zero when X and Y are —N(E₁₆)- and —N(E₁₇)-, respectively,
E₁₅ is a group —CO—C(E₁₈)═C(H)E₁₉ or, when Y is —N(E₁₇)—, forms together with E₁₇ a group —CO—CH═CH—CO—, wherein E₁₈ is hydrogen or methyl, and E₁₉ is hydrogen, methyl or —CO—X-E₂₀, wherein E₂₀ is hydrogen, C₁-C₁₂-alkyl or a group of the formula

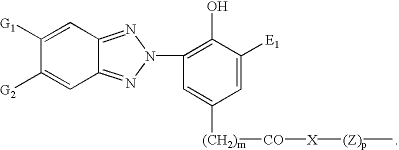

4. A process according to claim 1 where the hydroxyphenylbenzotriazoles are of the formula 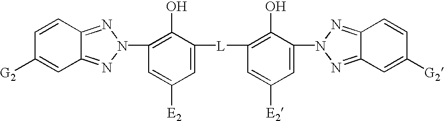
wherein
G₂ is —CF₃,
G_{2′} is hydrogen or —CF₃,
E₂ and E₂′ are independently straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; and
L is alkylene of 1 to 12 carbon atoms, alkylidene of 2 to 12 carbon atoms, benzylidene, p-xylylene, α,α,α′,α′-tetramethyl-m-xylylene or cycloalkylidene.

5. A process according to claim 1 where the hydroxyphenylbenzotriazoles are of the formula 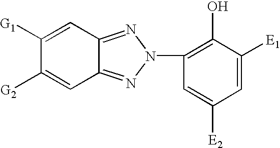
wherein
G₁ is hydrogen,
G₂ is —CF₃,
E₁ is phenylalkyl of 7 to 15 carbon atoms, phenyl, or said phenyl or said phenylalkyl substituted on the phenyl ring by 1 to 4 alkyl of 1 to 4 carbon atoms,
E₂ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or E₂ is said alkyl of 1 to 24 carbon atoms or said alkenyl of 2 to 18 carbon atoms substituted by one or more —OH, —OCOE₁₁, —NH₂ or —NHCOE₁₁, or mixtures thereof, or said alkyl or said alkenyl interrupted by one or more —O— and which can be unsubstituted or substituted by one or more —OH,
or where
G₁ is hydrogen,
G₂ is —CF₃,
E₁ is hydrogen, straight or branched alkyl of 4 to 24 carbon atoms or phenylalkyl of 7 to 15 carbon atoms, and
E₂ is as defined above.

6. A process according to claim 1 where the hydroxyphenylbenzotriazoles are of the formula 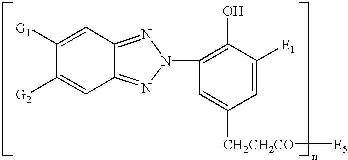
wherein
G₁ is hydrogen,
G₂ is —CF₃,
E₁ is hydrogen, straight or branched alkyl of 4 to 24 carbon atoms or phenylalkyl of 7 to 15 carbon atoms,
E₅ is —OE₆ or —NE₇E₈,
E₆ is hydrogen, straight or branched chain C₁-C₂₄alkyl which is unsubstituted or substituted by one or more OH groups, or —OE₆ is —(OCH₂CH₂)_{w}OH or —(OCH₂CH₂)_{w}OE₂₁ where w is 1 to 12 and E₂₁ is alkyl of 1 to 12 carbon atoms and
E₇ and E₈ are independently hydrogen, alkyl of 1 to 18 carbon atoms, straight or branched chain C₃-C₁₈alkyl which is interrupted by —O—, —S— or —NE₁₁—, C₅-C₁₂cycloalkyl, C₆-C₁₄aryl or C₁-C₃hydroxylalkyl, or E₇ and E₈ together with the N atom are a pyrrolidine, piperidine, piperazine or morpholine ring.

7. A process according to claim 1 wherein the hydroxyphenylbenzotriazoles are of the formula 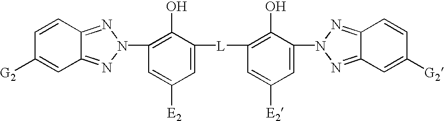
wherein
G₂ is —CF₃,
G_{2′} is hydrogen or —CF₃,
E₂ and E₂′ are independently straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms and
L is methylene.

8. A process according to claim 1 where the hydroxyphenylbenzotriazoles are selected from the group consisting of
(a) 5-trifluoromethyl-2-(2-hydroxy-3-α-cumyl-5-tert-octylphenyl)-2H-benzotriazole;
(b) 5-trifluoromethyl-2-(2-hydroxy-5-tert-octylphenyl)-2H-benzotriazole;
(c) 5trifluoromethyl-2-(2-hydroxy-3,5-di-tert-octylphenyl)-2H-benzotriazole;
(d) 2,2′-methylene-bis[6-(5-trifluoromethyl-2H-benzotriazol-2-yl)-4-tert-octylphenol];
(e) methylene-2-[4-tert-octyl-6-(2H-benzotriazol-2-yl)phenol]2′-[4-tert-butyl—(5-trifluoro-methyl-2H-benzotriazol-2-yl)phenol];
(f) 3-(5-trifluoromethyl-2H-benzotriazol-2-yl)-5-tert-butyl4-hydroxyhydrocinnamic acid;
(g) methyl 3-(5-trifluoromethyl-2H-benzotriazol-2-yl)-5-tert-butyl-4-hydroxy-hydrocinnamate;
(h) isooctyl 3-(5-trifluoromethyl-2H-benzotriazol-2-yl)-5-tert-butyl4-hydroxy-hydrocinnamate;
(i) 5-trifluoromethyl-2-[2-hydroxy-5-(3-hydroxypropyl)phenyl]-2H-benzotriazole;
(j) 5-butylsulfonyl-2-(2-hydroxy-3-α-cumyl-5-tert-octylphenyl)-2H-benzotriazole;
(k) 5-octylsulfonyl-2-(2-hydroxy-3,5-di-α-cumylphenyl)-2H-benzotriazole;
(l) 5-dodecylsulfonyl-2-(2-hydroxy-3,5-di-tert-butylphenyl)-2H-benzotriazole;
(m) 5-octylsulfonyl-2-(2-hydroxy-3,5-di-tert-octylphenyl)-2H-benzotriazole;
(n) 5-trifluoromethyl-2-(2-hydroxy-3-α-cumyl-5-tert-butylphenyl)-2H-benzotriazole;
(o) 5-trifluoromethyl-2-(2-hydroxy-3-α-cumyl-5-nonylphenyl)-2H-benzotriazole;
(p) 5-trifluoromethyl-2-[2-hydroxy-3-α-cumyl-5-(2-hydroxyethyl)phenyl]-2H-benzotriazole;
(q) 5-trifluoromethyl-2-[2-hydroxy-3-α-cumyl-5-(3-hydroxypropyl)phenyl]-2H-benzotriazole;
(r) 5-trifluoromethyl-2-(2-hydroxy-3,5-di-tert-amylphenyl)-2H-benzotriazole;
(s) 54rifluoromethyl-2-(2-hydroxy-3,5-di-tert-butylphenyl)-2H-benzotriazole;
(t) 5-trifluoromethyl-2-(2-hydroxy-3-dodecyl-5-methylphenyl)-2H-benzotriazole;
(u) 5-trifluoromethyl-2-[2-hydroxy-3-tert-butyl-5-(3-hydroxypropyl)phenyl)-2H-benzotriazole;
(v) 5-trifluoromethyl-2-[2-hydroxy-3-tert-butyl-5-(2-hydroxyethyl)phenyl]-2H-benzotriazole;
(w) 5-trifluoromethyl-2-12-hydroxy-5-(2-hydroxyethyl)phenyl]-2H-benzotriazole;
(x) 5-trifluoromethyl-2-(2-hydroxy-3,5-di-α-cumylphenyl)-2H-benzotriazole;
(y) 5-fluoro-2-(2-hydroxy-3,5-di-α-cumylphenyl)-2H-benzotriazole;
(z) 5-butylsulfonyl-2-(2-hydroxy-3,5-di-α-cumylphenyl)-2H-benzotriazole;
(aa) 5-butylsulfonyl-2-(2-hydroxy-3,5-di-tert-butylphenyl)-2H-benzotriazole;
(bb) 5-butylsulfonyl-2-(2-hydroxy-3,5-di-tert-octylphenyl)-2H-benzotriazole;
(cc) 5-phenylsulfonyl-2-(2-hydroxy-3,5-di-tert-butylphenyl)-2H-benzotriazole;
(dd) 5-chloro-2-(2-hydroxy-3,5-di-α-cumylphenyl)-2H-benzotriazole;
(ee) 5-chloro-2-(2-hydroxy-3-α-cumyl-5-tert-octylphenyl)-2H-benzotriazole;
(ff) isooctyl 3-(5-chloro-2H-benzotriazol-2-yl)-5-tert-butyl4-hydroxyhydrocinnamate;
(gg) 2-(2-hydroxy-3-α-cumyl-5-tert-octylphenyl)-2H-benzotriazole;
(hh) 2-(2-hydroxy-3,5-di-α-cumyl-phenyl)-2H-benzotriazole;
(ii) 5-chloro-2-(2-hydroxy-3,5-di-tert-butylphenyl)-2H-benzotriazole; and
(jj) 5-chloro-2-(2-hydroxy-3-tert-butyl-5-methylphenyl)-2H-benzotriazole.

9. A process according to claim 1 where in the α-hydroxy ketone photoinitiators,
R₁₁ and R₁₂ independently of one another are hydrogen, C₁-C₆ alkyl or phenyl or R₁₁ and R₁₂, together with he carbon atom to which they are attached, form a cyclohexyl ring; R₁₃ is OH; and R₁₄ is hydrogen, C₁-C₁₂ alkyl, C₁-C₁₂ alkoxy, —OCH₂CH₂OR₁₅, —C(CH₃)═CH₂ or is

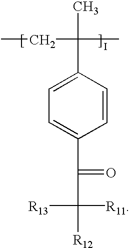

10. A process according to claim 1 where in the α-hydroxy ketone photoinitiators,
R₁₁ and R₁₂ independently of one another are methyl or ethyl or R₁₁, and R₁₂, together with the carbon atom to which they are attached, form a cyclohexyl ring; R₁₃ is hydrogen and R₁₄ id hydrogen, C₁C₄ alkyl, C₁-C₄ alkoxy or —OCH₂CH₂OH.

11. A process according to claim 1 where the α-hydroxy ketone photoinitiators are selected form the group consisting of
α-hydroxycyclohexyl phenyl ketone,
2-hydroxy-2-methyl-1-phenylpropanone,
2-hydroxy-2-methyl-1-(4-isopropylphenyl)propanone,
2-hydroxy-2-methyl-1-(4-dodecylphenyl)propanone and
2-hydroxy-2-methyl-1-[(2-hydroxyethoxy)phenyl]propanone.

12. A process according to claim 1 where in the bisacylphosphine oxide photoinitiators,
R₅₀ is C₂-C₁₀ alkyl, cyclohexyl or phenyl which is unsubstituted or is substituted by 1 to 4 C₁-C₄ alkyl, Cl or Br.

13. A process according to claim 1 where in the bisacylphosphine oxide photoinitiators,
R₅₀ is C₄-C₁₂ alkyl or cyclohexyl, R₅₁ and R₅₂ are each independently of the other C₁-C₈ alkyl and R₅₃ is hydrogen or C₁-C₈ alkyl.

14. A process according to claim 1 where in the bisacylphosphine oxide photoinitiators,
R₅₁ and R₅₂ are methyl and R₅₃ is hydrogen or methyl and R₅₀ is isobutyl or phenyl.

15. A process according to claim 1 where the bisacylphosphine oxide photoinitiator is bis(2,4,6-trimethylbenzoyl)-phenylphosphine oxide.

16. A process according to claim 1 where the hydroxyphenylbenzotriazoles are present from about 0.5% to about 5% by weight, based on the weight of the coating composition.

17. A process according to claim 1 where the hydroxyphenylbenzotriazole are present from about 2% to about 4% by weight, based on the weight of the coating composition.

18. A process according to claim 1 where the α-hydroxy ketone photoinitiators are present from about 1% to about 7% by weight, based on the weight of the coating composition.

19. A process according to claim 1 where the α-hydroxy ketone photoinitiators are present from about 2% to about 6% by weight, based on the weight of the coating composition.

20. A process according to claim 1 where the α-hydroxy ketone photoinitiators are present from about 3% to about 5% by weight, based on the weight of the coating composition.

21. A process according to claim 1 where the bisacylphosphine oxide photoinitiators are present from about 0.1% to about 2% by weight, based on the weight of the coating composition.

22. A process according to claim 1 where the bisacylphosphine oxide photoinitators are present from about 0.2% to about 1.5%, based on the weight of the coating composition.

23. A process according to claim 1 where the bisacylphosphine oxide photoinitators are present from about 0.5 to about 1% by weight, based on the weight of the coating composition.

24. A process according to claim 1 where the weight ratio of α-hydroxy ketone component i) to bisacylphosphine oxide component ii) is from about 5:1 to about 15:1.

25. A process according to claim 1 where the weight ratio of α-hydroxy ketone component i) to bisacylphosphine oxide component ii) is from about 7:1 to about 12:1.

26. A process according to claim 1 where the weight ratio of α-hydroxy ketone component i) to bisacylphosphine oxide component ii) is from about 8:1 to about 11:1.

27. A process according to claim 1 where the thickness of the protective film coating is from about 0.2 mil to about 5 mil.

28. A process according to claim 1 where the thickness of the protective film coating is from about 0.5 mil to about 3.5 mil.
